(19) United States
(12) Patent Application Publication
(10) Pub. No.: US 2018/0238506 A1
(43) Pub. Date: Aug. 23, 2018

(54) ILLUMINATION APPARATUS

(71) Applicant: PANASONIC INTELLECTUAL PROPERTY MANAGEMENT CO., LTD., Osaka (JP)

(72) Inventor: Atsushi MOTOYA, Shiga (JP)

(73) Assignee: PANASONIC INTELLECTUAL PROPERTY MANAGEMENT CO., LTD., Osaka (JP)

(21) Appl. No.: 15/890,703

(22) Filed: Feb. 7, 2018

(30) Foreign Application Priority Data
Feb. 21, 2017 (JP) 2017-030464

(51) Int. Cl. F21S 8/08; F21V 7/22; F21V 7/00; F21V 23/04; F21V 13/04

(52) U.S. Cl. CPC F21S 8/086; F21V 7/22; F21W 2131/103; F21V 23/0464; F21V 13/04; F21V 7/0008

(57) ABSTRACT

An illumination apparatus includes: an excitation light source; a light conveying member which conveys excitation light emitted by the excitation light source; a reflecting mirror which has a surface on which a wavelength conversion layer which includes a wavelength conversion material which converts a wavelength of the excitation light conveyed by the light conveying member is formed, and reflects light obtained by the wavelength conversion material converting the wavelength; and a support which supports the light conveying member and the reflecting mirror. The reflecting mirror is thermally connected with the support.

### CROSS REFERENCE TO RELATED APPLICATION

This application claims the benefit of priority of Japanese Patent Application Number 2017-030464 filed on Feb. 21, 2017, the entire content of which is hereby incorporated by reference.

### BACKGROUND

### 1. Technical Field

The present disclosure relates to an illumination apparatus which illuminates a street, for instance.

### 2. Description of the Related Art

As an illumination apparatus which illuminates, for instance, a street, an exterior illumination apparatus is known in which a light emitting diode (LED) light source is mounted (see Japanese Unexamined Patent Application Publication No. 2004-200102 and Japanese Unexamined Patent Application Publication No. 2013-020734, for example).

Japanese Unexamined Patent Application Publication No. 2004-200102 discloses an exterior illumination apparatus in which LED substrates on which LEDs are mounted are disposed.

Japanese Unexamined Patent Application Publication No. 2013-020734 discloses an exterior illumination apparatus in which a space for housing LED substrates on which LEDs are mounted can be reduced by changing a structure for supporting the LED substrates.

### SUMMARY

However, in the exterior illumination apparatus disclosed in Japanese Unexamined Patent Application Publication No. 2004-200102, since LED substrates are disposed, a space for housing the LED substrates is increased, and consequently a lighting component which includes the LED substrates also increases in size. According to the exterior illumination apparatus disclosed in Japanese Unexamined Patent Application Publication No. 2013-020734, a lighting component includes elements such as a heat sink and a power supply circuit, and thus the lighting component also increases in size due to the elements. A support (for example, a pole) which supports the lighting component needs to have a higher strength as the lighting component increases in size, and as a result, such an illumination apparatus often has a large size.

In view of this, the present disclosure has been achieved in light of such problems, and provides an illumination apparatus which includes a small lighting component.

In order to achieve such an illumination apparatus, an illumination apparatus according to an aspect of the present disclosure includes: an excitation light source; a light conveying member which conveys excitation light emitted by the excitation light source; a reflecting mirror which has a surface on which a wavelength conversion layer which includes a wavelength conversion material which converts a wavelength of the excitation light conveyed by the light conveying member is formed, and reflects light obtained by the wavelength conversion material converting the wavelength; and a support which supports the light conveying member and the reflecting mirror, wherein the reflecting mirror is thermally connected with the support.

According to an aspect of the present disclosure, an illumination apparatus which includes a small lighting component can be achieved.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a cross-sectional view illustrating a configuration of an illumination apparatus according to Embodiment 1;

FIG. 2 is a cross-sectional view illustrating a configuration of an illumination apparatus according to Embodiment 2;

FIG. 3 is a cross-sectional view illustrating a configuration of an illumination apparatus according to Embodiment 3;

FIG. 4 is a block diagram illustrating a functional configuration of the illumination apparatus according to Embodiment 3; and

FIG. 5 is a flowchart illustrating operation of the illumination apparatus according to Embodiment 3.

### DETAILED DESCRIPTION OF THE EMBODIMENTS

The following describes in detail embodiments of the present disclosure, with reference to the drawings. The embodiments described below each show a particular example of the present disclosure. Thus, the numerical values, shapes, materials, elements, the arrangement and connection of the elements, steps, and the processing order of the steps, for instance, shown in the following embodiments are mere examples, and therefore are not intended to limit the present disclosure. Thus, among the elements in the following embodiments, elements not recited in any of the independent claims defining the most generic part of the present disclosure are described as arbitrary elements.

The drawings are schematic diagrams and not necessarily provide strict illustration. Note that throughout the drawings, the same sign is given to substantially the same element, and redundant description is omitted or simplified.

The expression “approximately XX” is intended to include something that can be recognized as substantially XX. If a description is given using an “approximately rectangular solid shape” as an example, the “approximately rectangular solid shape” is intended to include not only a perfect rectangular parallelepiped, but also a shape that can be substantially recognized as a rectangular parallelepiped.

Some of the drawings used for description of the following embodiments show coordinate axes. The X axis, the Y axis, and the Z axis represent three axes of a three-dimensional rectangular coordinate system, where the Z-axis direction is a vertical direction, and a direction perpendicular to the Z axis (a direction parallel to the X-Y plane) is a horizontal direction. Note that the positive Z-axis direction is defined as a vertically downward direction (the direction toward the ground).

### Embodiment 1

The following describes an illumination apparatus according to the present embodiment.

### 1. Configuration of Illumination Apparatus

### [1-1. Entire Configuration of Illumination Apparatus]

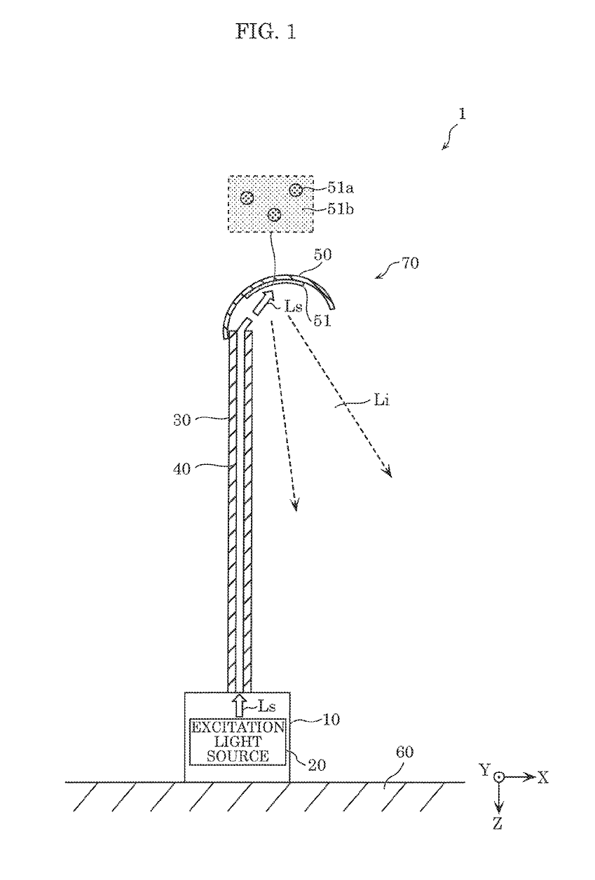

First, a description of the entire configuration of illumination apparatus 1 according to the present embodiment is given with reference to FIG. 1. FIG. 1 is a cross-sectional view illustrating a configuration of illumination apparatus 1 according to the present embodiment. Note that the cross-sectional view is a diagram illustrating a cross section of illumination apparatus 1 taken along a plane perpendicular to ground 60 on which illumination apparatus 1 is installed (a plane defined by the X axis and the Z axis in the present embodiment), and the same applies to the following description.

Illumination apparatus 1 is, for example, an exterior illumination apparatus which is installed outside and illuminates a street or a road, for instance. As illustrated in FIG. 1, illumination apparatus 1 includes light source casing 10, excitation light source 20, support 30, light conveying member 40, and reflecting mirror 50. Wavelength conversion layer 51 which includes a wavelength conversion material is formed on a lower surface of reflecting mirror 50 (a surface on the positive side of the Z axis).

The following describes in detail elements of illumination apparatus 1.

### [1-2. Light Source Casing]

A description of light source casing 10 is given with reference to FIG. 1.

Light source casing 10 is placed on ground 60 and holds excitation light source 20, for example. Light source casing 10 houses excitation light source 20 inside, and prevents excitation light source 20 from getting dust and moisture, for instance. Note that ground 60 is an example of an installation surface on which illumination apparatus 1 is installed.

Light source casing 10 includes a metal material or a non-metal material that has a high thermal conductivity, for example. Examples of a non-metal material having a high thermal conductivity include a resin having a high thermal conductivity (highly heat-conductive resin). Use of a material having a high thermal conductivity as the material of light source casing 10 allows dissipation of heat generated by excitation light source 20 to the outside via light source casing 10. The shape of light source casing 10 is an approximately rectangular parallelepiped, but is not limited thereto. For example, the shape of light source casing 10 may be an approximately cylindrical shape or may be another shape.

Support 30 is connected to a surface of light source casing 10 on a side opposite the side facing ground 60 (hereinafter referred to as the upper surface). For example, an opening (not illustrated) according to the shape of support 30 is formed in the upper surface of light source casing 10, and an end portion of support 30 on the ground 60 side (hereinafter referred to as the end portion) is inserted and fixed in the opening. Specifically, light source casing 10 serves to fix support 30. Thus, light source casing 10 is fixed onto ground 60 when illumination apparatus 1 is installed on the ground. For example, light source casing 10 may be fixed onto a concrete foundation, for instance.

Light source casing 10 is installed on or in the ground. In the present embodiment, light source casing 10 is installed on the ground. If light source casing 10 is installed on the ground, excitation light source 20 housed therein can be readily maintained. Furthermore, if light source casing 10 is installed in the ground, illumination apparatus 1 can be installed also at a place where there is not much space on the ground for installation. Whether light source casing 10 is installed on or in the ground is determined as appropriate.

Note that an example in which light source casing 10 houses excitation light source 20 has been described, yet the present embodiment is not limited to this. In the present embodiment, light source casing 10 also houses, for instance, a power supply circuit (not illustrated) which receives power supplied from a commercial power source (not illustrated), and generates power for causing excitation light source 20 to emit light, in addition to excitation light source 20. The power supply circuit (power supply unit) may include a rectifier transformer circuit which controls a voltage applied in order to control the output of excitation light source 20.

Furthermore, light source casing 10 may include, for example, although not illustrated, a display (for example, a liquid crystal display monitor) which displays information on excitation light source 20, such as an accumulated amount of light emission or an accumulated time of light emission, a receiver (for example, a switch or a touch panel) which adjusts the amount of light to be emitted by excitation light source 20, and a notifier (for example, a speaker or a lamp) which notifies, for instance, anomalies of excitation light source 20. Note that the display may also serve as the notifier. In other words, the display may display anomalies of excitation light source 20, for instance.

A portion of light source casing 10 may be formed using a light-transmitting material so that excitation light source 20 and others housed therein can be recognized from outside.

### [1-3. Excitation Light Source]

Next, excitation light source 20 is to be described, with reference to FIG. 1.

Excitation light source 20 is for emitting light toward reflecting mirror 50 via light conveying member 40. In order to increase a percentage at which light emitted by excitation light source 20 enters light conveying member 40 (for example, a fiber optic cable as later described), light emitted by excitation light source 20 may be distributed at a small angle. In the present embodiment, a laser light source is used as excitation light source 20. A laser light source has better convergence properties than an LED light source, and thus a percentage at which light enters light conveying member 40 can be increased. For example, the laser light source includes one or more semiconductor light emitting elements such as semiconductor lasers, and emits blue laser light Ls. Laser light Ls is an example of excitation light. Note that the laser light emitted by excitation light source 20 is not limited to blue laser light, and may be purple laser light, for example.

Laser light Ls emitted by excitation light source 20 as described above enters light conveying member 40 without passing through a wavelength conversion layer. This prevents a decrease in the percentage at which laser light Ls enters light conveying member 40, due to laser light Ls being diffused by the wavelength conversion layer.

Excitation light source 20 may include a condenser lens which controls distribution of laser light Ls in order to increase a percentage at which laser light La emitted by a light emitting element enters light conveying member 40. The condenser lens is an optical member which is disposed between light conveying member 40 and the light emitting element, condenses laser light Ls emitted by the light emitting element, and causes laser light Ls to enter light conveying member 40. For example, the condenser lens is a convex lens.

As described above, excitation light source 20 and the power supply circuit are housed in light source casing 10. In other words, excitation light source 20 and a power supply circuit are not disposed in lighting component 70 which is a part (illuminating part) through which illumination light Li is emitted. The present disclosure has a feature that lighting component 70 does not include excitation light source 20, a power supply circuit, and a heat sink. Specifically, lighting component 70 includes reflecting mirror 50. Thus, the weight and the size of lighting component 70 are decreased. Note that a heat sink will be later described in detail.

### [1-4. Supporting Member]

Next, support 30 is described with reference to FIG. 1.

Support 30 is an approximately elongated member (pole) which supports light conveying member 40. Specifically, support 30 is approximately cylindrical, and supports light conveying member 40 by housing light conveying member 40 inside. For example, support 30 supports light conveying member 40 such that the outer circumferential surface of light conveying member 40 and the inner circumferential surface of support 30 are in contact in a cross section of support 30 along a plane which crosses perpendicularly to the longitudinal direction of support 30 (a plane defined by the X axis and the Y axis in the present embodiment). Accordingly, stress is prevented from being applied to light conveying member 40 due to being bent. Note that the inner circumferential surface of support 30 and the outer circumferential surface of light conveying member 40 may not be in contact. In addition, the shape of support 30 is not limited to an approximately cylindrical shape, and may be an approximately cylindrical circular truncated cone, for example. When support 30 is viewed in the longitudinal direction (Z-axis direction) of support 30, the outline shape of support 30 is not limited to an approximately circular shape. Examples of the outline shape of support 30 when support 30 is viewed in the longitudinal direction may include an approximately elliptical shape or an approximately polygonal shape. For example, the shape of support 30 may be determined, taking into consideration of a fine appearance and a design of illumination apparatus 1.

The end portion of support 30 in the longitudinal direction is fixed to light source casing 10. Support 30 is installed approximately perpendicular to ground 60 since support 30 is fixed to light source casing 10. Reflecting mirror 50 is fixed to an end portion of support 30 on a side opposite ground 60 in the longitudinal direction (hereinafter referred to as the other end portion). Thus, support 30 supports reflecting mirror 50. Since reflecting mirror 50 is fixed to the other end, support 30 holds reflecting mirror 50 in a position that is at a predetermined height from ground 60.

Support 30 includes a metal material. A metal material is intended to include a metal simple substance and an alloy. For example, support 30 includes aluminum (Al), iron (Fe), aluminum alloy, or stainless steel, for instance. Support 30 has a high thermal conductivity since support 30 includes a metal material. For example, the thermal conductivity of support 30 is greater than or equal to 10 W/(mK). Accordingly, support 30 exhibits great heat dissipation.

Note that the material of support 30 is not limited to a metal material. Support 30 may include a material having a thermal conductivity greater than or equal to 10 W/(mK).

The height of support 30 (the length in the longitudinal direction, and the length in the Z-axis direction in the present embodiment) is determined as appropriate, taking into consideration a place where illumination apparatus 1 is installed, and variations and values of illuminance on an irradiation surface.

### [1-5. Light Conveying Member]

Next, light conveying member 40 is described, with reference to FIG. 1.

Light conveying member 40 is a member which extends from excitation light source 20 and has flexibility (is flexible), and is a fiber optic cable in the present embodiment. In illumination apparatus 1, a light source (excitation light source 20 in the present embodiment) and the illuminating part (reflecting mirror 50 in the present embodiment) are disposed separately from each other. Thus, light emitted by the light source needs to be conveyed to the illuminating part, and light conveying member 40 conveys the light.

Laser light Ls which has entered through an end portion (hereinafter referred to as the entering portion) of light conveying member 40 on the excitation light source 20 side is conveyed from excitation light source 20, and exits, toward reflecting mirror 50, from an end portion (hereinafter referred to as the exiting portion) of light conveying member 40 on a side opposite the excitation light source 20 side. Specifically, laser light Ls which passes through light conveying member 40 travels toward reflecting mirror 50.

Note that for example, the orientation of the exiting portion of flexible light conveying member 40 may be adjusted in order that light conveying member 40 causes laser light Ls to travel toward a predetermined area of reflecting mirror 50. Specifically, the exiting portion of light conveying member 40 may be bent toward the predetermined area of reflecting mirror 50. FIG. 1 illustrates an example in which the emission direction of laser light Ls is adjusted by directing the exiting portion of light conveying member 40 toward reflecting mirror 50. Note that how to adjust an area irradiated with laser light Ls which has exited light conveying member 40 is not limited to the above. For example, such adjustment may be made by controlling distribution of laser light Ls which has exited light conveying member 40, using a lens having predetermined light distribution characteristics.

### [1-6. Reflecting Mirror]

Next, reflecting mirror 50 is described, with reference to FIG. 1.

Reflecting mirror 50 is an illuminating part which causes illumination light Li to travel toward an irradiation surface (ground 60 or a road, for example) by reflecting laser light Ls which has exited light conveying member 40. In the present embodiment, the shape of reflecting mirror 50 is an approximately dome-like shape, and is fixed to support 30 such that an opening faces ground 60. Accordingly, laser light Ls which has exited light conveying member 40 is reflected by a surface of reflecting mirror 50 on the ground 60 side (hereinafter referred to as the internal surface), and thus illumination light Li can be caused to travel toward ground 60. Specifically, the illuminating part according to the present embodiment is a reflective device. Note that the shape of reflecting mirror 50 is not limited to the approximately dome-like state, and may be determined as appropriate according to the position and the size of an irradiation surface. For example, reflecting mirror 50 may have an approximately flat plate shape.

Reflecting mirror 50 has a thermal conductivity of 100 W/(mK) or higher, for example, and is formed using a light-reflective material. For example, reflecting mirror 50 is formed using a metal material such as aluminum, copper (Cu), or an aluminum alloy. Reflecting mirror 50 has a high thermal conductivity, and thus heat generated in wavelength conversion layer 51 due to laser light Ls entering wavelength conversion layer 51 can be readily transferred to reflecting mirror 50. Note that a member obtained by forming a metal layer on the surface of a substrate such as a resin or glass substrate may be employed as reflecting mirror 50.

As illustrated in FIG. 1, wavelength conversion layer 51 is formed on the internal surface of reflecting mirror 50. For example, wavelength conversion layer 51 is formed on the internal surface of reflecting mirror 50 by being applied thereon, for instance. Wavelength conversion layer 51 is formed using light-transmitting material 51b which contains yellow phosphors 51a. Wavelength conversion layer 51 is bound to reflecting mirror 50 by light-transmitting material 51b. In other words, light-transmitting material 51b is a binder for binding yellow phosphors 51a to reflecting mirror 50. Note that yellow phosphors 51a are dispersed in light-transmitting material 51b. For example, an yttrium aluminum garnet (YAG) phosphor is employed as yellow phosphor 51a. Yellow phosphor 51a is an example of a wavelength conversion material. Note that the internal surface of reflecting mirror 50 on which wavelength conversion layer 51 is formed is an example of a surface of reflecting mirror 50.

In the present embodiment, yellow phosphors 51a contained in wavelength conversion layer 51 convert a wavelength of a portion of, for example, blue laser light Ls into yellow light. Blue light not absorbed by yellow phosphors 51a and yellow light as a result of wavelength conversion by yellow phosphors 51a are diffused and mixed by wavelength conversion layer 51. Accordingly, white light exits from wavelength conversion layer 51. For example, reflecting mirror 50 reflects white light which has exited wavelength conversion layer 51 toward an irradiation surface (ground 60 in the present embodiment), whereby white illumination light Li is emitted through lighting component 70. Note that white light which has exited wavelength conversion layer 51 is an example of light as a result of wavelength conversion. Specifically, light as a result of wavelength conversion is light which has exited wavelength conversion layer 51.

Light-transmitting material 51b contains a light-transmitting inorganic material. Examples of the inorganic material include a glass material such as silicon dioxide (SiO₂) or zinc oxide. For example, light-transmitting material 51b includes only an inorganic material. Accordingly, compared to the case where an organic material (for example, a methyl silicone resin) is used for light-transmitting material 51b, deterioration of light-transmitting material 51b due to laser light Ls can be prevented. Generally, an inorganic material exhibits better heat dissipation than an organic material. Specifically, if light-transmitting material 51b contains an inorganic material, heat generated in wavelength conversion layer 51 due to laser light Ls entering wavelength conversion layer 51 can be readily transferred to reflecting mirror 50. Note that transparent YAG ceramics can also be used for wavelength conversion layer 51.

For example, a reflectance of light (hereinafter referred to as light reflectance) of the internal surface of reflecting mirror 50 may be improved by polishing, for instance. In order to increase light reflectance or to control light distribution, a dielectric multilayer film (not illustrated) may be formed between reflecting mirror 50 and wavelength conversion layer 51. Accordingly this allows mainly light having a particular wavelength, for example, to be reflected. Note that the dielectric multilayer film has a thickness of about several μm, and thus hardly influences the thermal resistance between wavelength conversion layer 51 and reflecting mirror 50. Thus, the dielectric multilayer film improves light-reflecting performance of reflecting mirror 50 while preventing an increase in the thermal resistance between wavelength conversion layer 51 and reflecting mirror 50.

Reflecting mirror 50 is thermally connected with the other end of support 30. “Reflecting mirror 50 and support 30 are thermally connected” is not limited to “reflecting mirror 50 and support 30 are directly connected” and is intended to include “reflecting mirror 50 and support 30 are connected via, for instance, another member (a metal member, for example)”. In the present embodiment, support 30 and reflecting mirror 50 are directly connected. Accordingly, heat generated by laser light Ls entering wavelength conversion layer 51 is transferred to support 30 via reflecting mirror 50, and the transferred heat is dissipated by support 30. Thus, illumination apparatus 1 according to the present embodiment can dissipate heat generated in the illuminating part (reflecting mirror 50 in the present embodiment) even if the illuminating part does not include a heat dissipating structure such as a heat sink. Accordingly, illumination apparatus 1 does not need to have, on the external surface of reflecting mirror 50, a heat dissipating structure such as a heat sink, for example. Stated differently, lighting component 70 of illumination apparatus 1 does not need to have a heat dissipating structure such as a heat sink.

### 2. Advantageous Effects

The following describes advantageous effects yielded by illumination apparatus 1 according to the present embodiment.

Illumination apparatus 1 according to the present embodiment includes: excitation light source 20; light conveying member 40 which conveys laser light Ls (an example of excitation light) emitted by excitation light source 20; reflecting mirror 50 which has an internal surface (an example of a surface) on which wavelength conversion layer 51 which includes yellow phosphor 51a (an example of a wavelength conversion material) which converts a wavelength of laser light Ls conveyed by light conveying member 40 is formed, and reflects light obtained by yellow phosphor 51a converting the wavelength; and support 30 which supports light conveying member 40 and reflecting mirror 50. Reflecting mirror 50 is thermally connected with support 30.

Accordingly, laser light Ls emitted by excitation light source 20 travels towards reflecting mirror 50 (an example of the illuminating part) through light conveying member 40. Thus, excitation light source 20 and reflecting mirror 50 can be disposed at different areas of illumination apparatus 1. In other words, excitation light source 20 does not need to be disposed in lighting component 70. Reflecting mirror 50 is thermally connected with support 30, and thus heat generated by laser light Ls entering wavelength conversion layer 51 (specifically, yellow phosphors 51a included in wavelength conversion layer 51) can be dissipated (conducted) to support 30 via reflecting mirror 50. Accordingly, a heat sink, for instance, does not need to be provided on reflecting mirror 50.

As described above, lighting component 70 of illumination apparatus 1 according to the present embodiment does not include a light source (for example, excitation light source 20) and a heat sink. Specifically, lighting component 70 includes only reflecting mirror 50. Accordingly, the size of lighting component 70 can be reduced in illumination apparatus 1 according to the present embodiment. Since the size of lighting component 70 is reduced, illumination apparatus 1 is less influenced by winds, for example.

Reflecting mirror 50 has a thermal conductivity higher than or equal to 100 W/(mK).

Accordingly, heat generated by irradiating wavelength conversion layer 51 formed on the internal surface of reflecting mirror 50 with laser light Ls can be efficiently dissipated to reflecting mirror 50.

Wavelength conversion layer 51 contains a binder (light-transmitting material 51b) which includes a light-transmitting inorganic material.

This more readily conducts heat generated in wavelength conversion layer 51 to reflecting mirror 50 than in the case where wavelength conversion layer 51 contains a binder which includes a light-transmitting organic material. Furthermore, when excitation light source 20 is a laser light source, wavelength conversion layer 51 (specifically, light-transmitting material 51b which is a binder) can be prevented from being deteriorated due to laser light emitted by the laser light source.

Excitation light source 20 is a laser light source.

Accordingly, since a laser light source emits light having excellent convergence properties, laser light Ls emitted by excitation light source 20 is allowed to efficiently enter light conveying member 40.

Support 30 includes a metal material.

Accordingly, support 30 includes a material having a high thermal conductivity. Specifically, heat from reflecting mirror 50 can be efficiently dissipated to support 30. Then, the heat is dissipated from support 30. Thus, since support 30 includes a metal material, heat can be efficiently conducted to support 30 and the conducted heat can be efficiently dissipated from support 30, and thus the heat dissipation characteristics of illumination apparatus 1 can be further improved.

### Embodiment 2

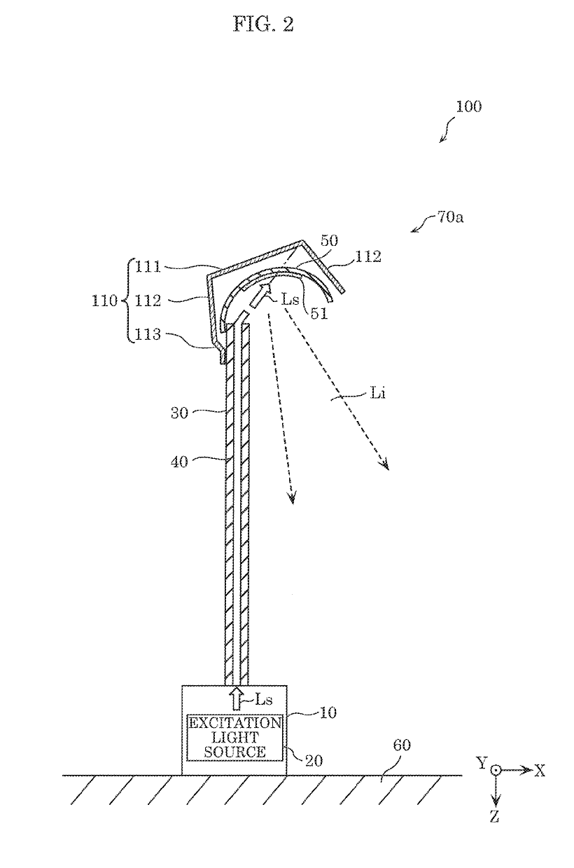

The following describes an illumination apparatus according to the present embodiment with reference to FIG. 2. FIG. 2 is a cross-sectional view illustrating a configuration of illumination apparatus 100 according to the present embodiment. Note that a description is given focusing on differences from Embodiment 1, and a description of a common configuration is omitted or simplified.

As illustrated in FIG. 2, illumination apparatus 100 includes housing 110 on the external surface side of reflecting mirror 50, in addition to illumination apparatus 1 according to Embodiment 1. Note that the configuration other than housing 110 is the same as the configuration of illumination apparatus 1 according to Embodiment 1. The external surface of the reflecting mirror is an example of another surface of the reflecting mirror.

Housing 110 is a cover member which covers the external surface of reflecting mirror 50. As illustrated in FIG. 2, housing 110 includes bottom 111, side portion 112 which extends from the outer edge portion of bottom 111 toward reflecting mirror 50, and flange 113 which extend from a portion of side portion 112. Flange 113 is fixed to support 30, whereby housing 110 is fixed to support 30. In this case, lighting component 70a of illumination apparatus 100 includes reflecting mirror 50 and housing 110.

Bottom 111 is a member having, for example, a flat plate shape and covers a portion of the external surface of reflecting mirror 50. For example, bottom 111 is disposed inclined relative to ground 60. Accordingly, for example, even when there is a snowfall, load is prevented from being applied to a portion where housing 110 and support 30 are connected, due to snow accumulating on bottom 111.

Side portion 112 is, for example, a frame shaped member, and covers a portion of the external surface of reflecting mirror 50. Side portion 112 extends from the outer edge portion of bottom 111 toward reflecting mirror 50. Specifically, in a plan view of bottom 111, side portion 112 is inclined relative to a direction perpendicular to bottom 111, outward from bottom 111 as side portion 112 is away from bottom 111. Note that the external surface of reflecting mirror 50 is covered by bottom 111 and side portion 112.

Flange 113 is a member for fixing housing 110 to support 30. Flange 113 is formed extending from a portion of an edge of side portion 112 on a side opposite bottom 111. Flange 113 and support 30 are fixed, whereby housing 110 is fixed to support 30. For example, flange 113 and support 30 are fixed using one or more screws (not illustrated). For example, an area of support 30 in which flange 113 and support 30 are fixed is different from an area of support 30 in which reflecting mirror 50 and support 30 are fixed. In other words, housing 110 and reflecting mirror 50 are fixed onto different areas of support 30.

Housing 110 is disposed, crossing an extended line (see the dash-double-dot line in FIG. 2) in a direction in which light conveying member 40 causes laser light Ls to travel toward reflecting mirror 50. Either bottom 111 or side portion 112 may cross the extended line. In the present embodiment, bottom 111 crosses the extended line.

Note that the shape of housing 110 is not limited to the above. Housing 110 may cover the external surface of reflecting mirror 50, and furthermore a portion of housing 110 may cross the extended line. For example, housing 110 may have the same shape as that of reflecting mirror 50 (an approximately dome-like shape in the present embodiment) or another shape. An air layer is present between housing 110 and reflecting mirror 50. Accordingly, even if housing 110 is heated by outdoor daylight, the heat is prevented from being transferred to reflecting mirror 50.

Housing 110 is formed using a material which blocks laser light Ls. Housing 110 is formed using a metal material such as aluminum, copper, or an aluminum alloy, for example. In other words, housing 110 is formed using a light-reflective material.

Note that housing 110 may be formed using a material which absorbs laser light Ls. In the present embodiment, since blue laser light Ls is used, housing 110 may be formed using a material which absorbs blue light. For example, housing 110 may be formed using a red or black resin material such as an acrylic resin (polymethyl methacrylate (PMMA)), polycarbonate (PC), or polybutylene terephthalate (PBT). This prevents, when reflecting mirror 50 is detached from support 30, laser light Ls which has exited light conveying member 40 from being reflected by the internal surface of housing 110, so that laser light Ls is not emitted toward ground 60. For example, laser light Ls is prevented from being emitted toward a walking person, so that laser light Ls does not impede the person. Note that the material of housing 110 is not limited to the above, and may be determined as appropriate according to the wavelength of laser light Ls emitted by excitation light source 20.

As described above, illumination apparatus 100 according to the present embodiment includes housing 110 which covers the external surface (an example of another surface) of reflecting mirror 50, and blocks laser light Ls (an example of excitation light).

Accordingly, if reflecting mirror 50 is detached from support 30 and laser light Ls (an example of excitation light) which has exited light conveying member 40 no longer falls on reflecting mirror 50 (in other words, in a state where laser light Ls is emitted upward in the sky), laser light Ls falls on housing 110. Since housing 110 blocks laser light Ls, and thus laser light Ls is blocked by housing 110. If laser light Le is emitted upward in the sky, the flight of an airplane may be impeded, for example. Since illumination apparatus 100 according to the present embodiment includes housing 110 which blocks laser light Ls, even if reflecting mirror 50 is detached from support 30, laser light Ls can be prevented from being emitted upward in the sky. Thus, illumination apparatus 100 improves safety.

Furthermore, illumination apparatus 100 includes housing 110, and thus reflecting mirror 50 can be protected from being directly hit by an object.

Stated differently, reflecting mirror 50 is prevented from being detached from support 30 by an object directly hitting reflecting mirror 50.

### Embodiment 3

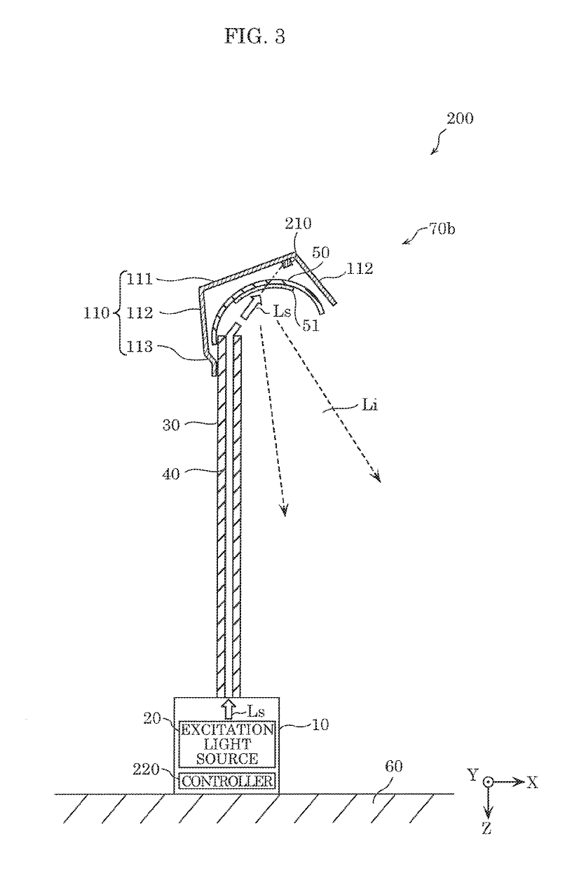

The following describes an illumination apparatus according to the present embodiment, with reference to FIGS. 3 to 5. Note that a description is given focusing on differences from Embodiment 2, and a description of a common configuration is omitted or simplified.

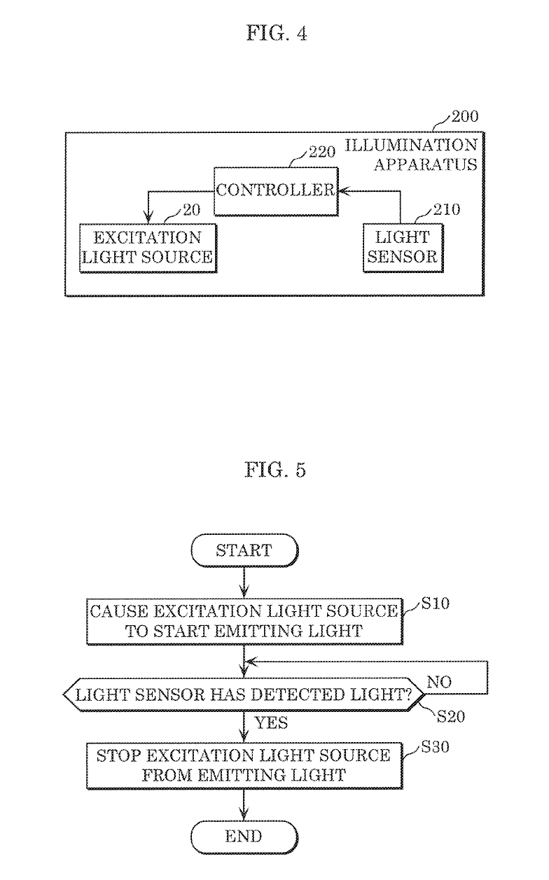

First, the entire configuration of illumination apparatus 200 according to the present embodiment is described with reference to FIGS. 3 and 4. FIG. 3 is a cross-sectional view illustrating the configuration of illumination apparatus 200 according to the present embodiment. FIG. 4 is a block diagram illustrating a functional configuration of illumination apparatus 200 according to the present embodiment.

As illustrated in FIG. 3, illumination apparatus 200 includes light sensor 210 and controller 220, in addition to illumination apparatus 100 according to Embodiment 2. Note that the configuration other than light sensor 210 and controller 220 is the same as the configuration of illumination apparatus 100 according to Embodiment 2.

In the present embodiment, light sensor 210 is disposed on a surface of housing 110 which faces reflecting mirror 50 (hereinafter referred to the internal surface). In this case, lighting component 70b of illumination apparatus 200 includes reflecting mirror 50, housing 110, and light sensor 210. Note that light sensor 210 is not limited to being disposed on the internal surface of housing 110, and may be disposed between reflecting mirror 50 and housing 110. Controller 220 is housed in light source casing 10, for example.

As illustrated in FIG. 4, illumination apparatus 200 includes excitation light source 20, light sensor 210, and controller 220 as a functional configuration.

Light sensor 210 is an image sensor for detecting light which has exited light conveying member 40. Stated differently, light sensor 210 is an image sensor for detecting laser light Ls emitted by excitation light source 20. Specifically, light sensor 210 detects at least light in a wavelength range from 380 nm to 500 nm. Light sensor 210 is a photo diode (PD), for example. Alternatively, light sensor 10 may include an image sensor such as a charge coupled device (CCD) or a complementary metal oxide semiconductor (CMOS), for example.

Note that light sensor 210 is for detecting laser light Ls emitted by excitation light source 20. Accordingly, housing 110 is formed using a material which blocks natural light in order not to allow light sensor 210 to detect natural light such as sunlight. Housing 110 is formed using a material which blocks at least natural light in a wavelength range which light sensor 210 detects. Housing 110 is formed using a metal material such as aluminum, copper, or an aluminum alloy, for example. Housing 110 may be formed using a material which absorbs natural light such as sunlight. For example, housing 110 may be formed using a black resin material such as an acrylic resin (PMMA), polycarbonate (PC), or polybutylene terephthalate (PBT).

Light sensor 210 is fixed onto the internal surface of housing 110. For example, light sensor 210 is fixed on an extended line in a direction in which light conveying member 40 causes laser light Ls to travel (see the dash-double-dot line in FIG. 3). In the present embodiment, light sensor 210 is fixed to housing 110 at an area that includes a point of contact between housing 110 and the direction in which laser light Ls travels.

Light sensor 210 fixed in such a manner does not detect laser light Ls when illumination apparatus 200 is normally emitting light. On the other hand, light sensor 210 detects laser light Ls when reflecting mirror 50 is detached from support 30 and laser light Ls no longer falls on reflecting mirror 50. Since light sensor 210 is disposed in a direction in which laser light Ls travels, light sensor 210 can detect laser light Ls when reflecting mirror 50 is detached from support 30. Stated differently, if a state where illumination apparatus 200 is not normally emitting light occurs such as when reflecting mirror 50 is detached from support 30 (for example, one or more screws for fixing flange 113 and support 30 have come out so that reflecting mirror 50 falls), light sensor 210 detects laser light Ls.

Controller 220 is a control device which controls excitation light source 20 according to the result of detection of laser light Ls by light sensor 210. If light sensor 210 detects laser light Ls, controller 220 controls excitation light source 20 to stop excitation light source 20 from emitting laser light Ls.

Controller 220 may be achieved by a program executer such as a CPU or a processor reading a program from an internal memory and executing the program. Alternatively, controller 220 may be achieved by a dedicated circuit.

Next, operation of illumination apparatus 200 is described with reference to FIG. 5. FIG. 5 is a flowchart illustrating operation of illumination apparatus 200 according to the present embodiment.

As illustrated in FIG. 5, illumination apparatus 200 starts illumination. For example, illumination apparatus 200 starts illumination after illumination apparatus 200 is installed. Specifically, for example, controller 220 controls excitation light source 20, and causes excitation light source 20 to start emitting light (S10). Accordingly, laser light Ls emitted by excitation light source 20 is reflected off reflecting mirror 50 via wavelength conversion layer 51. Specifically, reflecting mirror 50 (an example of an illuminating part) causes illumination light Li such as, for example, white light to travel. In the state where illumination apparatus 200 is normally operating, light sensor 210 does not detect laser light Ls (NO in S20), and thus controller 220 does not control excitation light source 20. In other words, excitation light source 20 is allowed to continue emitting light.

On the other hand, if light sensor 210 detects laser light Ls (YES in S20), controller 220 controls excitation light source 20, and stops excitation light source 20 from emitting light (S30). Accordingly, light emission by excitation light source 20 can be stopped if anomalies occur such as detachment of reflecting mirror 50 from support 30.

When reflecting mirror 50 and housing 110 are separately fixed to support 30, housing 110 and support 30 remain fixed even if reflecting mirror 50 is detached from support 30. Stated differently, light sensor 210 fixed to housing 110 can more reliably detect detachment of reflecting mirror 50 from support 30. Thus, even if housing 110 is detached from support 30 after reflecting mirror 50 is detached from support 30, laser light Ls is prevented from being emitted upward in the sky.

Note that light sensor 210 and controller 220 may communicate with each other in either a wired or wireless manner. When light sensor 210 has detected laser light Ls, controller 220 may transmit detection of laser light Ls to a person in charge of maintaining illumination apparatus 200, for example.

As described above, illumination apparatus 200 according to the present embodiment includes: light sensor 210 which is disposed on a surface of housing 110 which faces reflecting mirror 50, and detects laser light Ls (an example of excitation light); and controller 220 which stops excitation light source 20 from emitting laser light Ls when light sensor 210 detects laser light Ls.

Accordingly, when anomalies such as detachment of reflecting mirror 50 from support 30 occur in illumination apparatus 200, excitation light source 20 can be stopped from emitting light. For example, even if housing 110 is detached from support 30 after reflecting mirror 50 is detached from support 30, laser light Ls is prevented from being emitted upward in the sky, and thus illumination apparatus 200 further improves safety.

### OTHER EMBODIMENTS

The above completes description of the present disclosure, based on the embodiments, yet the present disclosure is not limited to the above embodiments.

For example, the above embodiments have each described an example in which an illumination apparatus is an exterior illumination apparatus, but the present disclosure is not limited thereto. Each of the illumination apparatuses according to the above embodiments is also applicable to an indoor illumination apparatus installed and used on a floor or a wall inside a house. For example, the illumination apparatuses are also applicable to floor lamps, table-lamp type illumination apparatuses (desk lamps), and bracket lights, for instance. For example, in this case, a floor and a wall are examples of the installation surfaces on which an illumination apparatus is installed.

The above embodiments have each described an example in which the illumination apparatus illuminates the installation surface on which the illumination apparatus is installed, yet the present disclosure is not limited thereto. For example, the illumination apparatus may illuminate a predetermined object such as a signboard.

The above embodiments have each described an example in which the excitation light source is a laser light source, yet the present disclosure is not limited thereto. For example, the excitation light source may be an LED light source which includes, as a light emitting element, an LED element which emits blue light or purple light. For example, the light emitting element is a chip on board (COB) LED element or a surface mount device (SMD) LED element. In this case, the wavelength conversion material such as yellow phosphors is not contained in a sealant. In other words, light emitted by the LED element enters a light conveying member without being subjected to wavelength conversion. Note that light emitted by the LED element is an example of excitation light. A laser light source may be used for the excitation light source in light of convergence of emitted excitation light.

The above embodiments have each described an example in which the wavelength conversion material is yellow phosphors, yet the present disclosure is not limited thereto. For example, the wavelength conversion material may be green phosphors and red phosphors. Specifically, white light may be generated using blue laser light and a wavelength conversion layer which contains green phosphors and red phosphors.

The above embodiments have each described an example in which one reflecting mirror is fixed to the support, yet the present disclosure is not limited thereto. For example, a plurality of reflecting mirrors may be fixed to the support. For example, excitation light sources and light conveying members may be disposed in one to one correspondence with the plurality of reflecting mirrors.

The above embodiments have each described an example in which the reflecting mirror is not provided with a heat sink, yet the present disclosure is not limited thereto. The reflecting mirror may be provided with a heat sink. However, in the above embodiments, the reflecting mirror and the support are thermally connected, and thus the size of the heat sink provided on the reflecting mirror can be decreased. Thus, even when a heat sink is provided, the size of the lighting component of the illumination apparatus can be decreased.

An example in which the wavelength conversion layer is formed on the internal surface of the reflecting mirror has been described, yet the present disclosure is not limited thereto. The wavelength conversion layer may be formed between the excitation light source and the entering portion of the light conveying member. Specifically, laser light emitted by the excitation light source enters from the entering portion of the light conveying member through the wavelength conversion layer. In other words, light (for example, white light) as a result of wavelength conversion enters the light conveying member.

Measures against salt damage may be taken for the illumination apparatuses described in the above embodiments. For example, acrylic-resin coating may be applied onto surfaces of the illumination apparatuses.

The present disclosure also encompasses embodiments as a result of adding, to the embodiments, various modifications that may be conceived by those skilled in the art, and embodiments obtained by combining elements and functions in the embodiments in any manner as long as the combination does not depart from the scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. An illumination apparatus, comprising:
an excitation light source;
a light conveying member which conveys excitation light emitted by the excitation light source;
a reflecting mirror which has a surface on which a wavelength conversion layer which includes a wavelength conversion material which converts a wavelength of the excitation light conveyed by the light conveying member is formed, and reflects light obtained by the wavelength conversion material converting the wavelength; and
a support which supports the light conveying member and the reflecting mirror, wherein
the reflecting mirror is thermally connected with the support.

2. The illumination apparatus according to claim 1, wherein
the reflecting mirror has a thermal conductivity higher than or equal to 100 W/(mK).

3. The illumination apparatus according to claim 1, wherein
the wavelength conversion layer contains a binder which includes a light-transmitting inorganic material.

4. The illumination apparatus according to claim 1, wherein
the excitation light source is a laser light source.

5. The illumination apparatus according to claim 1, wherein
the support includes a metal material.

6. The illumination apparatus according to claim 1, wherein
the support has a thermal conductivity higher than or equal to 10 W/(mK).

7. The illumination apparatus according to claim 1, wherein
the reflecting mirror is directly connected with the support.

8. The illumination apparatus according to claim 1, further comprising:
a housing which covers another surface of the reflecting mirror, and blocks the excitation light.

9. The illumination apparatus according to claim 8, wherein
an air layer is present between the housing and the reflecting mirror.

10. The illumination apparatus according to claim 8, further comprising:
a light sensor which is disposed on a surface of the housing which faces the reflecting mirror, and detects the excitation light; and
a controller which stops the excitation light source from emitting the excitation light when the light sensor detects the excitation light.

11. The illumination apparatus according to claim 10, wherein
the housing further blocks light in a wavelength range which the light sensor detects.

12. The illumination apparatus according to claim 1, wherein
the illumination apparatus is installed outside.
